(19) United States
(12) Patent Application Publication
(10) Pub. No.: US 2002/0161105 A1
(43) Pub. Date: Oct. 31, 2002

(54) Silicone emulsion containing dressing

(76) Inventors: James W. Rodgers, Suwanee, GA (US); Peter Kuklenyic, Lawrenceville, GA (US)

Correspondence Address: Hillary W. Hawkins, Esq., Williams Mullen Clark & Dobbins, Two James Center, 1021 East Cary Street, Richmond, VA, 23219, US

(21) Appl. No.: 10/077,046

(22) Filed: Feb. 14, 2002

Related U.S. Application Data
(60) Provisional application No. 60/268,424, filed on Feb. 14, 2001.

(51) Int. Cl. B05D 3/02; C08J 3/00; C08K 3/00; C08L 83/00

(52) U.S. Cl. 524/588; 427/387

(57) ABSTRACT

The present invention consists of improvements in silicone emulsion blends that provide a unique, useful and reliable composition and means for protecting and aesthetically enhancing the surface of rubber and other natural and synthetic polymers, leather, and wood. Specifically, the present invention consists of an emulsion blend comprising (1) an aqueous emulsion of polydimethylsiloxane and (2) an aqueous emulsion of organopolysiloxane which upon drying forms a solid elastomeric film of siloxane; and a polyol.

### CROSS REFERENCE TO RELATED APPLICATION

This application claims the benefit of U.S. Provisional Application No. 60/268424 filed in the United States Patent Office on Feb. 14, 2001.

### BACKGROUND OF THE INVENTION

1. Technical Field of the Invention

This invention relates to improvements in silicone emulsion blends and a process for protecting and aesthetically enhancing the surface of rubber and other natural and synthetic polymers, leather, and wood. The silicone emulsion blends of a polydimethylsiloxane fluid, or mixtures thereof, emulsifiers and water of the present invention solve several deficiencies in the prior art for protection and enhancements of such surfaces.

2. Discussion of the Related Art

Materials consisting of solutions of polydimethylsiloxane fluids in solvents, most of which are optically clear, and milky-white, aqueous emulsions of polydimethylsiloxane and other organic or organofunctional siloxane groups, have been applied to many surfaces including rubber and other natural and synthetic polymers, such as vehicle tires, leather, and wood. These emulsions and the method of applying same as a protective treatment and to enhance the aesthetics of such surfaces as the synthetic polymers found in tires and vehicles, is known in the art.

As those skilled in the art can appreciate, the term “emulsion” is generally recognized as meaning a stable mixture of two or more mutually immiscible liquids held in suspension by small percentages of substances known as surfactants or emulsifiers. Further, the use of non-ionic surfactants are utilized because they provide certain desirable emulsion-stability properties.

Prior efforts to resolve the need for protective treatments and aesthetic enhancement had many undesirable characteristics. Materials previously used as protective treatments and for aesthetic enhancement include solutions of silicone fluids in solvents that are applied to surfaces requiring a dry, clean surface, extended drying period, and repeated application to maintain a reflective appearance on the surface. These materials are combustible, toxic, and highly corrosive to metal and painted surfaces frequently failing to adhere to the surface and shedding the material in the form of a staining discharge, for example U.S. Pat. No. 4,246,029. These types of materials such as those taught in U.S. Pat. No. 5,433,890 when applied and then exposed to environmental elements such as water, dirt and the like, lose their reflective appearance quickly and frequently cause damage to property as the material sheds from the applied surface.

Prior efforts to restore the appearance of surfaces such as a soiled tire, as taught by U.S. Pat. No. 4,133,921 and U.S. Pat. No. 3,956,174, have the advantage of requiring repeated application(s) which is solved by the present invention.

By contrast, the present invention is a “Dressing” defined as a material consisting of blends of silicone emulsions and silicone elastomeric emulsions, later defined herein, which has a reflective appearance on a surface for several days without repeated application. It is an object of the present invention to provide a Dressing that is non-toxic and easy to apply because its formulation does not require extensive cleaning or preparation of the surface prior to application to obtain the highly desirable reflective appearance. The Dressing has an instant affinity to a wet surface. After drying, the Dressing solves other known deficiencies in the prior art because it is chemically inert, repels water and exhibits lubricating and heat stability properties.

It is another object of the invention to provide a Dressing to protect the surface from damage caused by exposure to common environmental elements such as water, dirt and the like.

### SUMMARY OF THE INVENTION

A process for making and applying a Dressing in accordance with the present invention that provides a highly reflective appearance or “wet look” on rubber and other natural and synthetic polymers, leather, and wood enhances the aesthetics of its appearance. Both a clear and a translucent material may be made by various ratios of an aqueous emulsion of dimethylpolysiloxane fluids blended with an aqueous emulsion of organic substituted polysiloxane of which forms an elastomeric, solid film upon drying, and a polyol. These blended compositions may be sprayed, wiped, brushed or otherwise applied to either a dry, or a thoroughly water-wet, clean, or moderately-soiled surface of a polymeric substrate leaving a level, uniform appearance. The components do not include hazardous hydrocarbons that are known to damage the environment. The result achieved with the blends is different and better than the result achieved from the individual components.

This invention relates to improvements in materials for providing a Dressing, which results in a superior gloss with extended durability to the out-of-doors environment and vehicle operations. By altering the ratios of the components of the Dressing, an unexpected property of the invention is an optical clarity of such that one may read writing through a clear container holding the blend. This type of clarity is normally found with polysiloxane fluids in solvent solutions. These solutions are presently a large part of the retail market for tire Dressing.

Another unexpected desirable property of the present invention is that when applied to a water-wet surface it will retain an even, uniform gloss after the water has dried from the Dressing. The ability of the present invention to be applied on a wet surface address a disadvantage in the prior art because the present invention allows for reduced drying time when used in automated applications such as a car wash, specifically with conveyor or auto in-bay systems. Yet another advantageous property is that abrasives such as soil and the like do not adhere well to the Dressing. Other high-molecular weight elastomers of polysiloxanes would typically attract soil. The composition of the present invention does not. These and other features and objects of the present invention will become apparent from a consideration of the detailed description.

### BRIEF DESCRIPTION OF THE DRAWINGS

No drawings are included.

### DETAILED DESCRIPTION

To one skilled in the art, silicones can be useful components in formulations for treating rubber and other synthetic polymer surfaces in order to enhance the aesthetics and retain the appearance.

One component of the invention, Component A, is an aqueous emulsion of a polydimethylsiloxane stabilized in the emulsion by one or more ionic or non-ionic surfactant(s) or emulsifiers. Said silicone emulsions are readily available and suitable for use as a component of this invention. The siloxane in the aqueous emulsion can be a linear or branched chain siloxane fluid having a viscosity at 25° C. in the range of 300-60,000 mm² or centistokes, most preferably between 350-10,000 centistokes. The particle size of the polydimethysiloxane is from 0.2 microns to 10.0 microns, preferably 0.5 microns in the emulsion. The emulsion typically contains 20% to 60%, by weight, of the siloxanes. Conventional non-ionic surfactants can be used to prepare the emulsion, such as an ethoxylated fatty alcohol or ethoxylated alkyl-phenol as taught in U.S. Pat. No. 5,681,377; however, other commercially available non-ionic surfactants are suitable.

Another component of the invention, Component B, is an aqueous emulsion or microemulsion of a branched, extremely high-molecular weight, organopolysiloxane that contains organo alkyl functional groups. Such organopolysiloxane fluids are well known in the art, for example U.S. Pat. No. 4,509,981, having the general formula R₃SiO—(SᵢOR₂)ₙ—SiR₃ in which R represents monovalent hydrocarbons such as methyl, ethyl, propyl, dodecyl and octadecyl radicals and the like, and n is a number greater than 5.

The emulsion is prepared using emulsion polymerization techniques well known in the art and as taught by U.S. Pat. No. 2,891,920 to provide high-molecular weight, organopolysiloxanes emulsified in water. The emulsion typically contains 20% to 50%, by weight, of the extremely high-molecular weight, organo-polysiloxane (preferably 35% to 45%, by weight, of the siloxane). The particle size of the organo polysiloxane is normally less than 0.2 micron. Conventional non-ionic surfactants can be used to prepare the emulsion, such as ethoxylated fatty alcohols or ethoxylated alkyl-phenol; however, other commercially available non-ionic surfactants are suitable. The emulsion typically contains 2% to 15%, by weight, of the non-ionic surfactant (preferably 5% to 12%), the remaining balance being water. The emulsion immediately, upon drying of water, leaves a rubber-like, white, solid, non-tacky elastomer film on a substrate. The high-molecular weight organo-polysiloxane within the emulsion has an instant affinity for either water-wet or dry rubber and other synthetic polymer substrates. Such an emulsion is commercially available from Taylor Chemical Company; however, no other manufacturer is known to the applicant, there may be other commercially available emulsions that would be suitable. An additional method for preparing component B that may be employed in this invention is generally defined in U.S. Pat. No. 5,017,297.

Another component of the invention, Component C, is at least one water-miscible or water-soluble polyol, for example 1,2,3 propanetriol or glycerin, liquid polyethylene glycols, and liquid polypropylene glycols; however, other such commercially available polyols are suitable. For the present invention, the preferred polyol is glycerin because it exhibits a highly reflective appearance also known to the trade as a “wet look.”

The invention is a composition created by blending the following: Component A, Component B and Component C; and may also include other common adjuvants found in such products, including wetting agent, antifoam agent, preservative, dye or coloring agent, corrosion inhibitor, freeze-thaw additive, ultraviolet absorber, antimicrobial agent, and plasticizer. Temperature and pH restrictions are relevant only during formulation of the individual components. A suitable temperature is a temperature less than the lowest cloud point of the emulsifiers present. The suitable pH is 4 to 8.5, preferably 6. The finished emulsion has the stability as understood in the prior art of polydimethylsiloxane emulsions.

### EXAMPLES

The following examples are present to further illustrate the composition of this invention, but are not to be construed as limiting the invention, which is delineated in the appended claims. In these examples and accompanying tables the term Component A′ is a preferred formulation of the above disclosed Component A namely, an aqueous emulsion containing polydimethylsiloxane having a viscosity of approximately 350 centistokes. The siloxane is stabilized in the emulsion by non-ionic surfactants and has diameter greater than 0.2 microns.

Component B′ is a preferred formulation of the above disclosed Component B namely, an aqueous emulsion of an organofunctional polysiloxane of high-molecular weight. A sample of the emulsion, when dried, forms a solid elastomeric film of siloxane. The siloxane was stabilized in the emulsion by non-ionic surfactants. Therefore, as used herein an “Emulsion Blend” means a mixture of said Component A′ and said Component B′. The Emulsion Blend contains approximately 70-95 weight percent of Component A′ and approximately 5-30 weight percent of Component B′.

### EXAMPLE 1

A composition according to the present invention is prepared as follows: Component A′ is blended with Component B′ so that the approximate ratio of Component A′ to Component B's is 85% to 15%. The product is an Emulsion Blend that was then blended with Component C, here glycerin, and water as follows:

| | |
|---|---|
| Glycerin | 38.08 Weight Parts |
| Water | 12.28 Weight Parts |
| Emulsion Blend | 52.64 Weight Parts |

The present invention is the resultant blend that was mechanically mixed with a low-shear mixing device until the blend was uniform. The present invention was optically clear. When the present invention was dried of water, a non-tacky, white, solid film formed.

When applied to dry rubber surface the invention produced a highly reflective appearance on the treated surface. The treated surface was exposed to water, dirt and abrasive material twice daily for one week and maintained its highly reflective appearance and was easily washed free of dirt and dust with a water rinse.

The present invention was also applied to dry, clean rubber surface and produced a similar highly reflective appearance on the treated surface. The treated surface was exposed to water, dirt and abrasive material intermittently for one week and maintained its highly reflective appearance and was easily washed free of dirt and dust with a water rinse.

Finally, the present invention was also applied to a thoroughly water wet rubber surface and produced a similar highly reflective appearance on the treated surface. The treated surface was exposed to water, dirt and abrasive material intermittently for one week with only a minimal reduction in its original highly reflective appearance and was easily washed free of dirt and dust with a water rinse.

### EXAMPLE 2

A composition according to the present invention was prepared as follows: Component A′ was blended with Component B′ so that the approximate ratio of Component A′ to Component B′ was 90% to 10%. The product is an Emulsion Blend that was then blended with Component C, here glycerin, and water as follows:

| | |
|---|---|
| Glycerin | 10.0 Weight Parts |
| Water | 38.0 Weight Parts |
| Emulsion Blend | 52.0 Weight Parts |

The present invention is the resultant blend that was mechanically mixed with a low-shear mixing device until the blend was uniform. The present invention formed a milky white liquid. When the present invention was dried of water, a non-tacky, white, solid film formed.

When applied to dry rubber surface the invention produced a highly reflective appearance on the treated surface. The treated surface was exposed to water, dirt and abrasive material daily for one week and approximately maintained its highly reflective appearance and was easily washed free of dirt and dust with a water rinse.

The present invention was also applied to a thoroughly water wet surface and produced a highly reflective appearance on the treated surface. The treated surface was exposed to water, dirt and abrasive material intermittently for one week with only a minimal reduction in its original highly reflective appearance and was easily washed free of dirt and dust with a water rinse.

Finally, the present invention was also applied to a thoroughly water wet synthetic polymer surface and produced a highly reflective appearance on the treated surfaces. The treated surface was exposed to water, dirt and abrasive material intermittently for one week with only a minimal reduction in its original highly reflective appearance and was easily washed free of dirt and dust with a water rinse.

### EXAMPLE 3

A composition according to the present invention was prepared as follows: Component A′ was blended with Component B′ so that the approximate ratio of Component A′ to Component B′ was 90% to 10%. The product is an Emulsion Blend that was then blended with Component C, here glycerin, and water as follows:

| | |
|---|---|
| Glycerin | 7.0 Weight Parts |
| Water | 54.0 Weight Parts |
| Emulsion Blend | 39.0 Weight Parts |

The present invention is the resultant blend that was mechanically mixed with a low-shear mixing device until the blend was uniform. The present invention formed a milky white liquid. When the present invention was dried of water, a non-tacky, white, solid film formed.

When applied to dry rubber surface the invention produced a highly reflective appearance on the treated surface. The treated surface was exposed to water, dirt and abrasive material daily for one week and maintained its highly reflective appearance, although somewhat less reflective than as observed from the product described in Example 2 above, and was easily washed free of dirt and dust with a water rinse.

The present invention was also applied to a thoroughly water wet rubber surface and produced a highly reflective appearance on the treated surface. The treated surface was exposed to water, dirt and abrasive material intermittently for one week with only a minimal reduction in its original highly reflective appearance, although somewhat less reflective than as observed from the product described in Example 2 above, and was easily washed free of dirt and dust with a water rinse.

Finally, the present invention was also applied to a thoroughly water wet synthetic polymer surface and produced a highly reflective appearance on the treated surfaces. The treated surface was exposed to water, dirt and abrasive material intermittently for one week with only a minimal reduction in its original highly reflective appearance, although somewhat less reflective than as observed from the product described in Example 2 above, and was easily washed free of dirt and dust with a water rinse.

### EXAMPLE 4

A composition according to the present invention was prepared as follows: Component A′ was blended with Component B′ so that the approximate ratio of Component A′ to Component B′ was 85% to 15%. The product is an Emulsion Blend that was then blended with Component C, here glycerin, and water as follows:

| | |
|---|---|
| Glycerin | 7.0 Weight Parts |
| Water | 59.2 Weight Parts |
| Emulsion Blend | 33.0 Weight Parts |

The present invention is the resultant blend that was mechanically mixed with a low-shear mixing device until the blend was uniform. The present invention was milky white. When the present invention was dried of water, a non-tacky, white, solid film formed.

Therefore, the present invention provides a unique, useful and reliable composition and means for protecting and aesthetically enhancing the surface of rubber and other natural and synthetic polymers, leather, and wood.

Many improvements, modifications, and additions will be apparent to the skilled artisan without departing from the spirit and scope of the present invention as described herein and defined in the following claims:

We claim:

1. A coating composition comprising:
(a) an emulsion blend comprising:
(1) an aqueous emulsion of polydimethylsiloxane and
(2) an aqueous emulsion of organopolysiloxane which upon drying forms a solid elastomeric film of siloxane; and
(b) a polyol.

2. The composition of claim 1 further comprising water.

3. The composition of claim 2 wherein said emulsion blend is approximately 50 weight percent of said coating composition, said polyol is approximately 40 weight percent of said coating composition and said water is approximately 10 weight percent of said coating composition.

4. The composition of claim 2 wherein said emulsion blend is approximately 50 weight percent of said coating composition, said polyol is approximately 10 weight percent of said coating composition and said water is approximately 40 weight percent of said coating composition.

5. The composition of claim 2 wherein said emulsion blend is approximately 40 weight percent of said coating composition, said polyol is approximately 10 weight percent of said coating composition and said water is approximately 50 weight percent of said coating composition.

6. The composition of claim 2 wherein said emulsion blend is approximately 35 weight percent of said coating composition, said polyol is approximately 5 weight percent of said coating composition and said water is approximately 60 weight percent of said coating composition.

7. The composition of claim 1 wherein said emulsion of polydimethylsiloxane is approximately 70 to approximately 95 weight percent of said emulsion blend and said emulsion of organopolysiloxane is approximately 5 to approximately 30 weight percent of said emulsion blend.

8. The composition of claim 1 wherein said aqueous emulsion of polydimethylsiloxane is comprised of polydimethylsiloxane, an emulsifier and water.

9. The composition of claim 8 wherein said emulsifier is ionic.

10. The composition of claim 8 wherein said emulsifier is non-ionic.

11. The composition of claim 10 wherein said emulsifier is selected from the group consisting of ethoxylated fatty alcohol and ethoxylated alkyl-phenol.

12. The composition of claim 8 wherein said aqueous emulsion of polydimethylsiloxane contains approximately 20 weight percent to approximately 60 weight percent of polydimethylsiloxane.

13. The composition of claim 8 wherein said polydimethylsiloxane particle size is approximately 0.2 to approximately 10.0 microns.

14. The composition of claim 13 wherein said particle size is approximately 0.5 microns.

15. The composition of claim 8 wherein said polydimethylsiloxane has a viscosity of approximately 300 to approximately 60,000 centistokes at 25° C.

16. The composition of claim 15 wherein said viscosity is approximately 350 to approximately 10,000 centistokes at 25° C.

17. The composition of claim 1 wherein said an aqueous emulsion of organopolysiloxane is comprised of organopolysiloxane, an emulsifier and water.

18. The composition of claim 17 wherein said emulsion of organopolysiloxane comprises approximately 20 to approximately 50 weight percent organopolysiloxane.

19. The composition of claim 18 wherein said emulsion of organopolysiloxane comprises approximately 35 to approximately 45 weight percent organopolysiloxane.

20. The composition of claim 17 wherein said organopolysiloxane particle size is approximately 0.2 microns.

21. The composition of claim 17 wherein said emulsifier is non-ionic.

22. The composition of claim 21 wherein said emulsifier is selected from the group consisting of ethoxylated fatty alcohol and ethoxylated alkyl-phenol.

23. The composition of claim 1 wherein said polyol is selected from the group comprising 1,2,3 propanetriol, polyethylene glycols and polypropylene glycols.

24. The composition of claim 23 wherein said polyol is 1,2,3 propanetriol.

25. A method of providing a protective finish to a surface which comprises applying the coating composition of claim 1 to said surface.

26. The method of claim 25 wherein said surface is selected from the group consisting of rubber, polymers, leather and wood.
